(19) United States
(12) Patent Application Publication
(10) Pub. No.: US 2014/0050430 A1
(43) Pub. Date: Feb. 20, 2014

(54) BEARING AND LUBRICATION SYSTEM USED THEREWITH

(71) Applicants: Timothy P. Murphy, Canton, OH (US); Phillip E. Jackson, Canton, OH (US); Steven D. Olson, Massillon, OH (US)

(72) Inventors: Timothy P. Murphy, Canton, OH (US); Phillip E. Jackson, Canton, OH (US); Steven D. Olson, Massillon, OH (US)

(73) Assignee: The Timken Company, Canton, OH (US)

(21) Appl. No.: 14/009,816

(22) PCT Filed: Apr. 24, 2012
(86) PCT No.: PCT/US12/34770

§ 371 Date: Oct. 4, 2013

Related U.S. Application Data
(60) Provisional application No. 61/478,729, filed on Apr. 25, 2011.

(51) Int. Cl. F16C 33/66

(52) U.S. Cl. CPC F16C 33/6648
USPC 384/400; 384/322

(57) ABSTRACT

A bearing includes an outer ring (14) having an inner surface (26), an inner ring (18) at least partially positioned within the outer ring (14) and having an outer surface (22) in facing relationship with the inner surface (26), a groove (30) defined in either the inner surface (26) or the outer surface (22), and a porous material (38) positioned in the groove (30) in which lubricant is absorbed. The porous material (38) is configured to secrete the absorbed lubricant in response to being compressed.

### CROSS-REFERENCE TO RELATED APPLICATIONS

This application claims priority to co-pending U.S. Provisional Patent Application No. 61/478,729 filed on Apr. 25, 2011, the entire content of which is incorporated herein by reference.

### FIELD OF THE INVENTION

The present invention relates to bearings, and more particularly to lubrication systems used in bearings.

### BACKGROUND OF THE INVENTION

Traditionally, lubrication grooves are cut into surfaces on bearing rings to enhance grease distribution between load carrying surfaces or load zones on the rings. In constant speed and/or full rotation applications, such grooves can be effective because the rotating components leave the load zone and move into a lubricant-rich area of the bearing to acquire a film of lubricant before re-entering the load zone. In slow, small displacement and/or oscillatory applications, the lubricant is often wiped away from the contacting surfaces of the bearing after repeated cycling, allowing metal to metal contact. Such contact may damage (e.g., by micro-welding or galling) the ring surface.

Elaborate lubrication groove patterns have been developed in bearings used in small displacement and/or oscillatory applications to improve the distribution of the lubricant, but such patterns typically require constant re-lubrication to replace lubricant that is displaced during operation.

### SUMMARY OF THE INVENTION

The present invention provides a bearing that provides continuous re-lubrication to contact surfaces on the bearing rings that are lubrication-starved due to the conditions in which the bearing assembly is used (e.g., during small displacement and/or oscillatory applications).

The present invention provides, in one aspect, a bearing including an outer ring having an inner surface, an inner ring at least partially positioned within the outer ring and having an outer surface in facing relationship with the inner surface, a groove defined in either the inner surface or the outer surface, and a porous material positioned in the groove in which lubricant is absorbed. The porous material is configured to secrete the absorbed lubricant in response to being compressed.

Other features and aspects of the invention will become apparent by consideration of the following detailed description and accompanying drawings.

### BRIEF DESCRIPTION OF THE DRAWINGS

FIG. 1 is a perspective view of a bearing of the present invention.

FIG. 2 is a cross-sectional view of the bearing of FIG. 1 installed in a housing.

FIG. 3 is a side view of an inner ring of the bearing of FIG. 1.

FIG. 4 is a cross-sectional view of the inner ring shown in FIG. 3 along line 4-4 in FIG. 3

FIG. 5 is a cross-sectional view of the inner ring shown in FIG. 3 along line 5-5 in FIG. 4

FIG. 6 is an enlarged view of a portion of the inner ring shown in FIG. 5.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

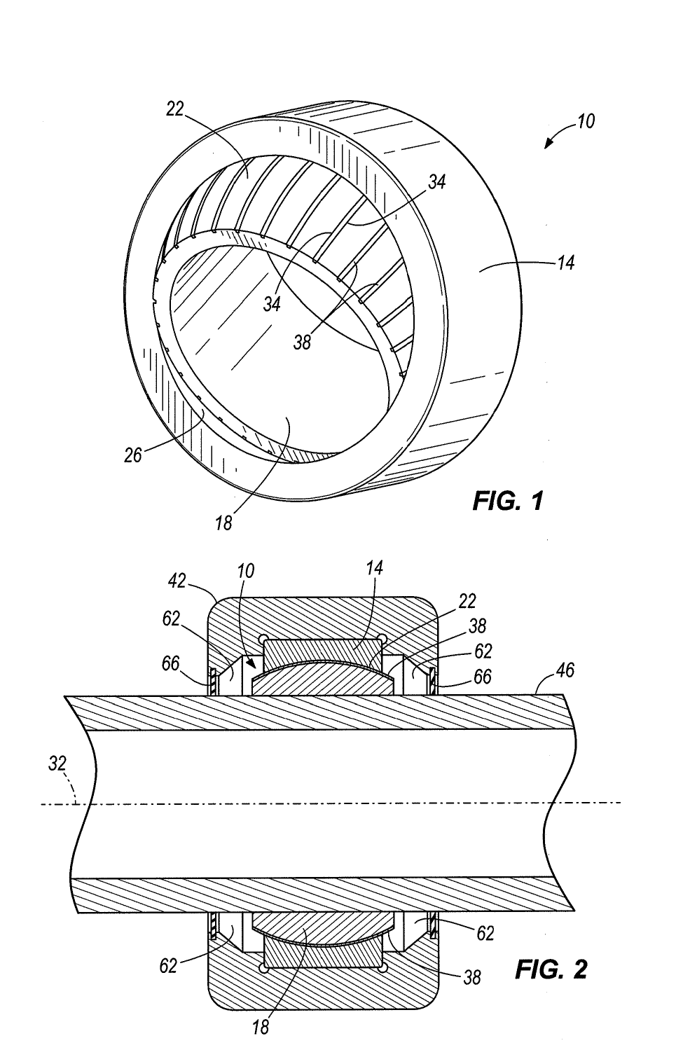

FIG. 1 illustrates a bearing 10 including an outer ring 14 and an inner ring 18 at least partially positioned within the outer ring 14. In the illustrated construction, the bearing 10 is configured as a spherical plain bearing 10 in which the inner ring 18 includes a convex or spherical outer raceway or surface 22 and the outer ring 14 includes a concave inner raceway or surface 26 in facing relationship with the outer surface 22 of the inner ring 18 (see also FIG. 2). As is discussed in more detail below, in operation of the bearing 10, a lubricant film is maintained between the outer and inner raceways or surfaces 22, 26 to facilitate relative movement between the rings 14, 18. One or both of the surfaces 22, 26 may be coated to further reduce friction between the surfaces 22, 26. Alternatively, the bearing 10 may be configured as a spherical roller bearing, a cylindrical roller bearing, a ball bearing, a tapered roller bearing, and so forth.

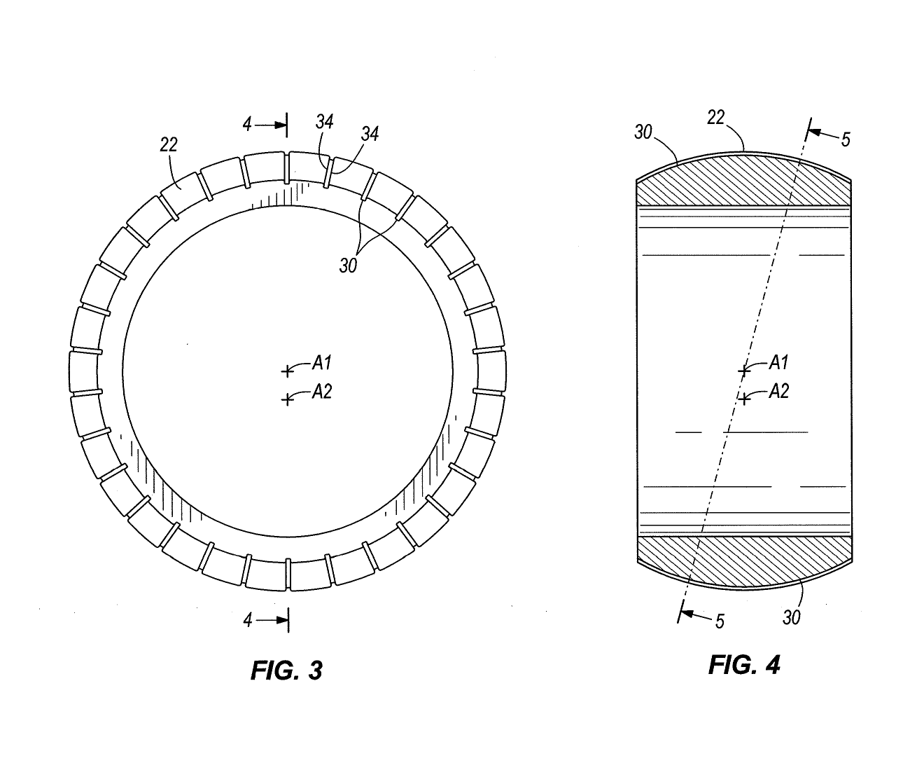

With reference to FIG. 3, the bearing 10 includes a plurality of grooves 30 defined in the spherical outer surface 22 of the inner ring 18. The grooves 30 are oriented in a direction substantially parallel with a central axis 32 of the rings 14, 18 (FIG. 2). Consequently, adjacent grooves 30 are substantially parallel (FIG. 1). The grooves 30 are also equally spaced from each other about the circumferential periphery of the outer surface 22 of the inner ring 18. Each of the grooves 30 includes two edges 34 between which the width of the groove 30 is defined. At least a portion of the outer surface 22 adjacent each of the edges 34 is defined by at least one of a radius, a series of radii, and an arcuate profile or transition to reduce the stress on the spherical outer surface 22 in the vicinity of the edges 34.

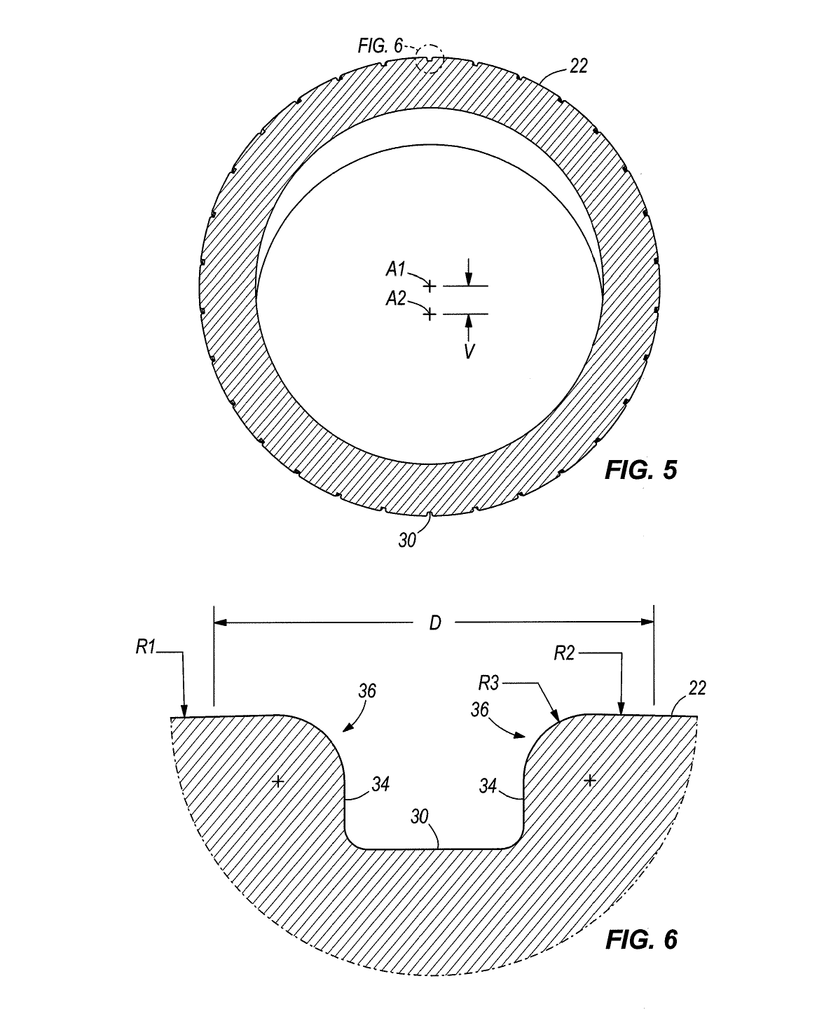

Particularly, with reference to FIG. 6, the outer surface 22 is profiled or shaped to incorporate an arcuate transition 36 between the outer surface 22 and each of the edges 34 for each groove 30. Such an arcuate transition 36 reduces stress that might otherwise develop along the edges 34 in absence of the arcuate transitions 36 when the bearing 10 is loaded. In the illustrated construction of the bearing 10, the outer surface 22 of the inner ring 18 is profiled or shaped using three different radii. A majority of the outer surface 22 is defined by a first or main body radius R1 with an axis A1 located coaxially with the central axis 32 (FIGS. 3-5). In other words, the main body radius R1 is equal to one-half of the nominal diameter of the inner ring 18.

A second or blend radius R2 (FIG. 6) is slightly larger than the main body radius R1 and includes an axis A2 that is offset from the axis A1 by a value V (FIGS. 3-5). The offset value V is chosen such that only a small amount of material is removed from the outer surface 22 when forming the blend radius R2 to provide a smooth transition from the main body radius R1 toward the edge 34 of each of the grooves 30. For example, in the illustrated construction of the bearing 10, appropriate values are chosen for the blend radius R2 and the offset value V such that the difference of the blend radius R2 and the offset value V is less than the main body radius R1 by only 0.0003 inches.

With reference to FIG. 6, a third or closing radius R3 is much smaller than either of the radii R1, R2 and transitions the blend radius R2 into the vertical edge 34 of each of the grooves 30. For example, in the illustrated construction of the bearing 10, the closing radius R3 is less than 1% of the main body radius R1. More particularly, the closing radius R3 is about 0.8% of the main body radius R1. The profiled shape of the outer surface 22 as defined by the radii R1, R2, and R3 minimize localized stress risers along the edges 34 of each of the grooves 30, thereby yielding a substantially uniform load distribution along the edges 34 of the grooves 30. The blend radius R2 and the closing radius R3, on each side of each of the grooves 30, together define the arcuate transition 36 between the outer surface 22 and each of the groove edges 34. The arcuate transitions 36 on either side of a groove 30 in addition to the width of the groove 30 itself span a linear dimension D along the circumference of the outer surface 22 (FIG. 6). In the illustrated construction of the bearing 10, the dimension D may be between about 5% of the main body radius R1 and about 10% of the main body radius R1.

With continued reference to FIG. 6, the profiled outer surface 22 may be shaped using a multi-step machining process. First, the main body radius R1 is machined on the inner ring 18. Then, the blend radius R2 is machined on either side of each of the grooves 30 using an offset tool which takes into consideration the offset value V to provide a smooth transition from the main body radius R1 toward the edge 34 of each of the grooves 30. Lastly, the closing radius R3 is machined on either side of the grooves 30 for transitioning the blend radius R2 into the vertical edge 34 of each of the grooves 30.

With reference to FIG. 1, the bearing 10 also includes a porous material 38 positioned in each of the grooves 30. The porous material 38 includes a height sufficient to slightly protrude above the spherical outer surface 22 of the inner ring 18. As is discussed in more detail below, lubricant or base oil therein may be absorbed by the porous material 38 and subsequently secreted in response to the porous material 38 being compressed as it passes through a loading zone between the outer and inner rings 14, 18 to supplement or replenish the lubricant film between the rings 14, 18. The porous material 38 may be configured as an oil-impregnated polymer, such as that available under the trade name MICROPOLY from PhyMet, Inc. in Springboro, Ohio. When configured as an oil-impregnated polymer, the porous material 38 is manufactured (e.g., using a molding process) in thin strips and inlaid or interference fit with the respective grooves 30. Alternatively, the porous material 38 may be configured as an industrial felt. When configured as an industrial felt, the porous material 38 may be adhesively coupled to the inner ring 18.

With reference to FIG. 2, the bearing 10 is shown installed within a housing 42, with a shaft 46 being supported by the inner ring 18 for articulation relative to the housing 42. Respective seals 66 are secured to the housing 42 to effectively define a closed end of an annular cavity or reservoir 62 on each side of the bearing 10 in which lubricant (e.g., grease) is held or maintained for use during operation of the bearing 10. The seals 66 extend from the housing 42 and toward the shaft 46 for sliding contact with the shaft 46. The seals 66 are installed on the housing 42 after the bearing 10 and the reservoirs 62 are packed with lubricant. Alternatively, the seals 66 may be secured or otherwise attached to the shaft 46 and extend toward the housing 42 to define the reservoirs 62. This quantity of lubricant serves a dual purpose. Firstly, some of the lubricant within the reservoirs 62 is absorbed by the porous material 38 and subsequently distributed to the surfaces 22, 26 (described in more detail below). Secondly, the lubricant in each of the reservoirs 62 functions as a barrier to debris ingress.

In operation of the bearing 10, at least one end of the porous material 38 in at least one of the grooves 30 is exposed to or in contact with lubricant held in an adjacent reservoir 62. The porous material 38 absorbs some of the base oil from the grease within the reservoirs 62 and distributes it throughout the porous material 38 via capillary attraction or “wicking” to saturate the porous material 38. After an initial number of loading cycles of the bearing 10, the initial amount of lubricant supplied to the loading zone(s) of the bearing 10 (i.e., portions of the surfaces 22, 26 being loaded by the housing 42 or the shaft 46) during the initial packing process of the bearing 10 may become depleted. Subsequently, the saturated porous material 38 may secrete some of its absorbed lubricant in response to being compressed as the porous material 38 passes through a loading zone of the bearing 10. The secreted lubricant supplements or replenishes the film of lubricant between the outer and inner rings 14, 18 as the bearing 10 continues operation. Lubricant may be secreted from the porous material 38 in a substantially continuous manner to supplement or replenish the lubricant film without having to re-pack the bearing 10, which might otherwise require the apparatus in which the bearing 10 is incorporated to be shut down or taken out of service. Accordingly, the service life of the bearing 10 is likely to be increased without having to conduct any additional preventative maintenance on the bearing 10 than what is ordinarily required.

Various features of the invention are set forth in the following claims.

1. A bearing comprising:
an outer ring having an inner surface;
an inner ring at least partially positioned within the outer ring and having an outer surface in facing relationship with the inner surface;
a groove defined in one of the inner surface and the outer surface; and
a porous material positioned in the groove in which lubricant is absorbed, wherein the porous material is configured to secrete the absorbed lubricant between the inner and outer rings in response to being compressed.

2. (canceled)

3. The bearing of claim 1, wherein the groove is defined in the outer surface of the inner ring.

4. The bearing of claim 3, wherein the groove is oriented in a direction substantially parallel with a central axis of the inner and outer rings.

5. The bearing of claim 1, wherein the groove is a first of a plurality of grooves defined in one of the inner surface and the outer surface.

6. The bearing of claim 5, wherein a second of the plurality of grooves is located adjacent the first groove, and wherein the first and second grooves are substantially parallel.

7. The bearing of claim 5, wherein the plurality of grooves are equally spaced from each other about the periphery of the one of the inner surface and the outer surface.

8. The bearing of claim 1, wherein the bearing is configured as a spherical plain bearing, and wherein the outer surface of the inner ring includes a spherical shape.

9. The bearing of claim 8, wherein the groove is defined in the spherical outer surface of the inner ring.

10. The bearing of claim 1, wherein the groove includes an edge proximate the spherical outer surface, and wherein the outer surface is defined by a first radius, a second radius blending the first radius and the edge of the groove, and a third radius further blending the second radius and the edge of the groove.

11. (canceled)

12. (canceled)

13. The bearing of claim 10, wherein the first radius is centered on a first axis, wherein the second radius is greater than the first radius, and wherein the second radius is centered on a second axis that is offset from the first axis.

14. The bearing of claim 10, wherein the third radius is less than about 1% of the first radius.

15. The bearing of claim 1, wherein the porous material is one of an oil-impregnated polymer and an industrial felt.

16. The bearing of claim 1, wherein the porous material is one of inlaid and interference fit with the groove.

17. An assembly comprising:
a housing;
a bearing, as set forth in claim 1, positioned within the housing; and
a shaft supported by the bearing for articulation relative to the housing.

18. The assembly of claim 17, further comprising a lubricant reservoir between the housing and the shaft, wherein oil from the lubricant is absorbed by the porous material of the bearing, and wherein the porous material is configured to secrete the absorbed lubricant in response to being compressed.
